(19) United States
(12) Patent Application Publication
(10) Pub. No.: US 2010/0117968 A1
(43) Pub. Date: May 13, 2010

(54) DATA INPUT APPARATUS

(76) Inventor: No-Soo Park, Daejeon (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/528,114

(22) PCT Filed: Jan. 9, 2008
(86) PCT No.: PCT/KR2008/000114

§ 371 Date: Aug. 21, 2009

(30) Foreign Application Priority Data
Feb. 21, 2007 (KR) 10-2007-0017570

(51) Int. Cl. G06F 3/02

(52) U.S. Cl. 345/168; 345/173

(57) ABSTRACT

The present invention describes a data input apparatus and a data input method that implement a large number of key values with a small number of switches to improve a text input and implement an efficient text input with small volume. The data input apparatus of the present invention is configured of press switches including touch sensors on a plate and forms a unit cell configured of neighboring switches, each cell and neighboring unit cells shares the switches. The data input step selects the unit cell by a simultaneous touch of two touch switches positioned at each diagonal direction in the unit cell, activates the selected unit cell on the display, and inputs the corresponding key values by means of any one switch of four switches included in the selected unit cell.

### TECHNICAL FIELD

The present invention relates to a data input apparatus, and more specifically to an apparatus inputting data such as characters, etc. in portable devices such as a cellular phone, a PDA, a small laptop computer, a remote controller requiring a data input, and the like.

### BACKGROUND ART

A data transmission using a short message service (SMS) has rapidly been increased in recent years and a data input in a portable computer or a PDA has been epoch-makingly increased due to activation of wireless internet in recent years. If an interactive TV is commercialized afterwards, it can be expected that a data input through a remote controller will be generalized.

As a common data input method in a current small portable device, there are a keypad circulating method (for example, a->b->c) that selects and inputs a desired key values by pressing keys on the keypad several times to circulate data and a method using a micro keyboard.

In the case of using the keypad circulating method, in order to input desired key values, it repeats an operation that selects one key and then circulates data by performing a press operation several times to select and input the key value. As a result, since the method should press many keys per word, there is a problem in that it takes much time to input the keys and it is easy to make a mistake in inputting the keys.

In the case of using the micro keyboard, there is a problem in that it requires a relatively larger volume and it should input data with watching the keyboard at all times so that it has a limitation in applying to a small device.

Meanwhile, as the data input method in another form in the small portable device, there is a method of inputting data by means of a cell selection according to a movement of a direction key and an input of a key input switch corresponding to the selected cell. In this case, since the cell selection should be performed according to the movement of the direction key and the data are input by means of the input of the key input switch after the cell selection, the direction key and the key input switch should alternately be input so that there is a problem in that it takes much time to perform the key input. Also, since the method requires the same number of the key input switches as the key values corresponding to the corresponding cell, it requires a large number of the key input switches. Therefore, there is a problem in that a large space for the key input switches is required and the mistake frequently occurs in inputting the keys.

### DISCLOSURE

### [Technical Problem]

An object of the present invention provides a small and efficient data input apparatus capable of inputting data more rapidly and efficiently than a keypad by implementing more key values in the same external shape as the currently used keypad and intuitionally inputting data with a reduction of a position movement of a finger in inputting keys due to a smaller volume than a method using a micro keyboard and without watching the keyboard due to a easy position confirmation of the keys.

### [Technical Solution]

The data input apparatus according to the present invention is to implement a data input apparatus capable of inputting more words in the same external shape as the keypad through a blind touch, i.e., intuitionally inputting data. The data input apparatus comprises input switches where touch switches and press switches are integrally provided, wherein four neighboring input switches form one unit cell, each unit cell and neighboring unit cells share switches, the data input is performed by inputting the corresponding key values by selecting the unit cell through a touch operation and then selecting one of the four input switches configuring the unit cell and pressing it.

To this end, a data input apparatus of the present invention comprises input switches arranged in a matrix form where press switches and touch switches are integrally provided, four neighboring input switches being allocated to one unit cell and unit cells being allocated in a matrix form so as to mutually share input switches on a border line of neighboring unit cells, characterized in that when input signals are input from the touch switches by a simultaneous touch of more than two input switches including a diagonal switches in the unit cell, the unit cell including the touched input switches is activated; when signals are input from the press switches by a press operation of any one input switch configuring the activated unit cell, key values allocated to the input switches within the activated unit cell are input;

and the activated unit cell by the touch of the touch switch remains activated before the neighboring unit cells sharing the input switches are activated.

The data input apparatus of the present invention is characterized in that the one unit is allocated with the four neighboring input switches to the one unit cell to input a plurality of key values while maintaining a limited number of the input keys and mutually share the input switches on the border line between the neighboring unit cells, thereby inputting key values four times as large as the number of unit cells.

The data input apparatus further comprises cell selection auxiliary switches provided at the outside of the input switches positioned at an outermost arranged in a matrix form so that the unit cell corresponding to the simultaneous touch of the input switches positioned at the outermost is activated only by the touch of the cell selection auxiliary switch.

Further, the data input apparatus of the present invention is characterized in that when the input signals are input from the touch switches by a simultaneous touch of more than two input switches including the diagonal switches in the unit cell in order to accurately select the unit cell, the unit cell including the touched input switch is activated to minimize an error selection of the unit cell caused by an error touch of the input switches within the neighboring unit cells in a selection step of the unit cell. The meaning of the simultaneous touch is that more than two touch switches including the diagonal switches in the unit cell are simultaneously touched and the touch switches in the unit cell are sequentially touched within predetermined time, and in particular, includes one recognized as the simultaneous touch when the touch switch first touched in the unit cell has predetermined touch holding time from the time of the first touch and the touch point in time of the touch switch last touched is in the touch holding time and one recognized as the simultaneous touch when the touch point in time of the touch switch first touched and the touch point in time of the touch switch last touched in the unit cell are in predetermined time.

When adopting the touch holding time in the sequential touch, it is preferably within 0.05 seconds in consideration of a feature of the touch operation and when adopting the touch point in time, it is preferably within 0.1 seconds.

The data input apparatus according to the present invention is characterized in that after the unit cell selected by means of the touch recognition method is implements an input of accurate key values according to the press operation of one input switch of the four input switches configuring the activated unit cell and in order to prevent an error input caused from the press operation of the input switch configuring the unit cell other than the activated unit cell, when the unit cell is activated, it operates only the press switches of the four input switches configuring the activated unit cell.

Also, the unit cell activated by the touch of the touch switch of the data input apparatus according to the present invention remains activated before the neighboring unit cells sharing the input switches are activated. Also, the input switch adopted in the present invention is provided in a dome shape protruded upward and the touch switch is formed only at a central portion of the dome.

Also, the present invention displays the activated unit cell information and the input key value information on a plate 10 or a display 20 around the input switch to prevent the error input.

### DESCRIPTION OF DRAWINGS

FIG. 1 is a view showing a mobile phone keypad;

FIG. 2 is a perspective view implementing forty key values including an alphabet of A-Z as a key pad configured of press switches including eighteen touch sensors;

FIG. 3 is a view showing a data input example using the data input apparatus according to the present invention;

FIG. 4 is a view showing a region of touch switches used for defining a cell selection method;

FIG. 5 is a view showing a data input method using the data input apparatus according to the present invention;

FIGS. 6 and 7 are views showing a data input method using a data input apparatus in another form according to the present invention;

FIG. 8 is a view for explaining a simultaneous touch; and

FIG. 9 is a cross-sectional view showing a switch structure of a data input apparatus according to the present invention.

### BEST MODE

Hereinafter, a data input apparatus and a data input method of the present invention will be described in detail with reference to accompanying drawings.

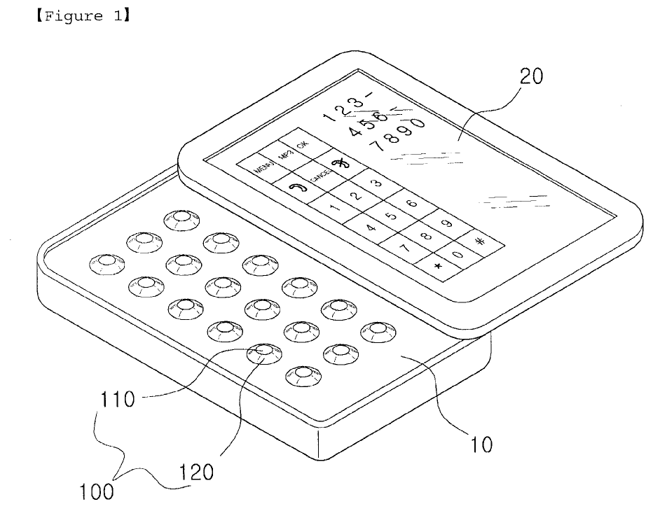

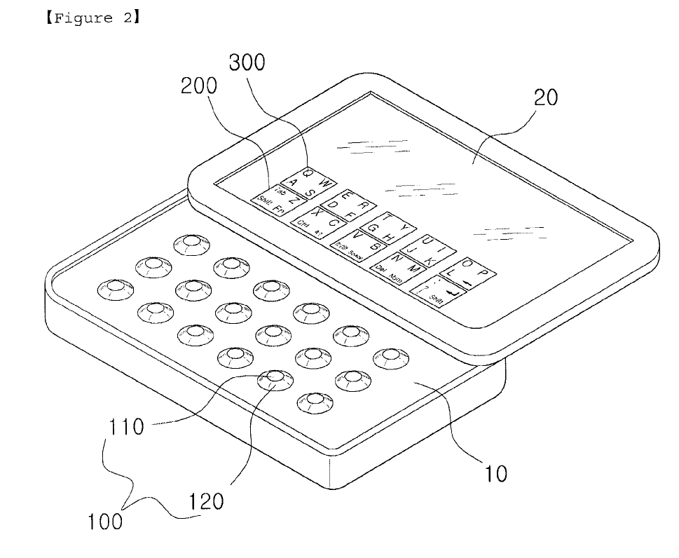

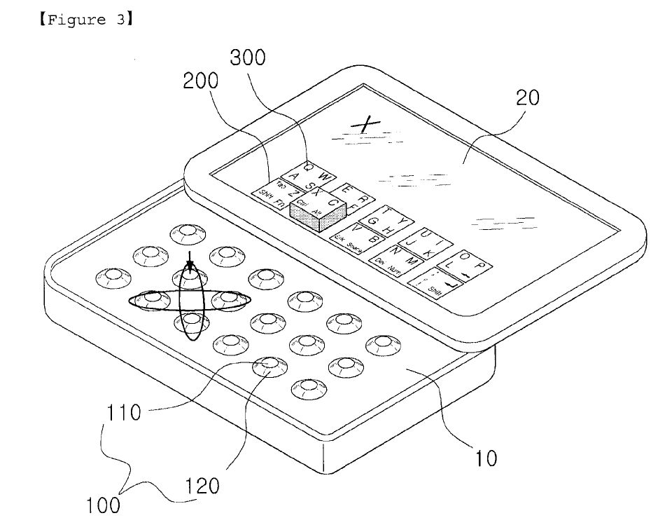

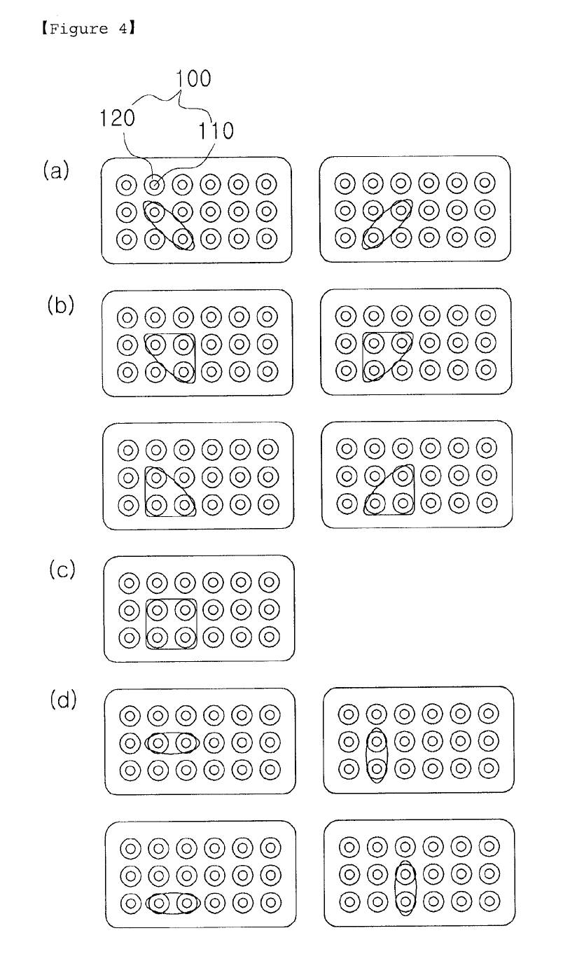

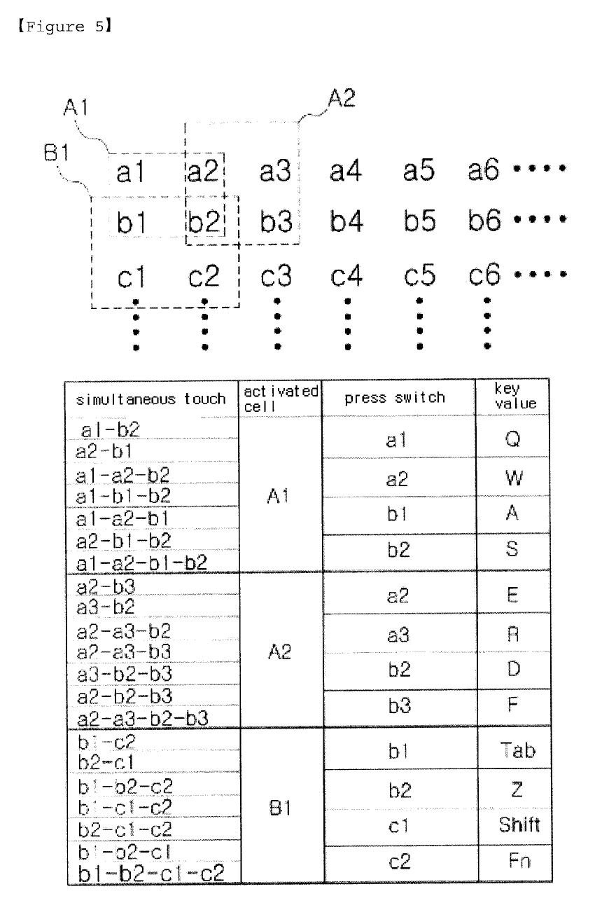

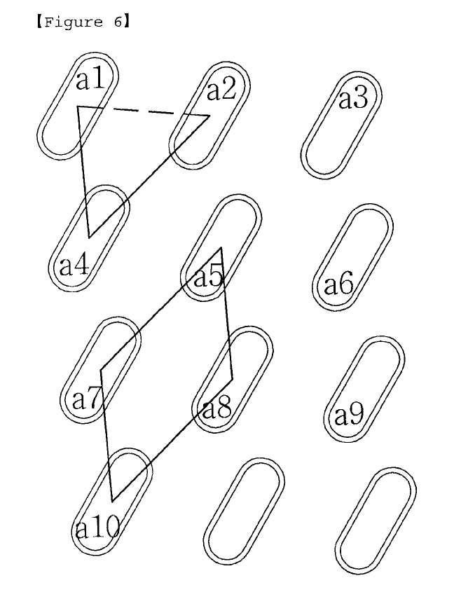

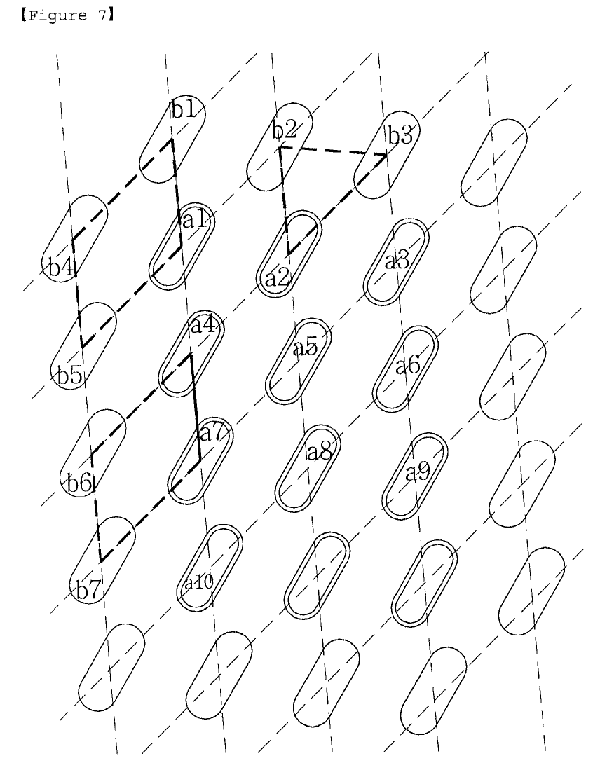

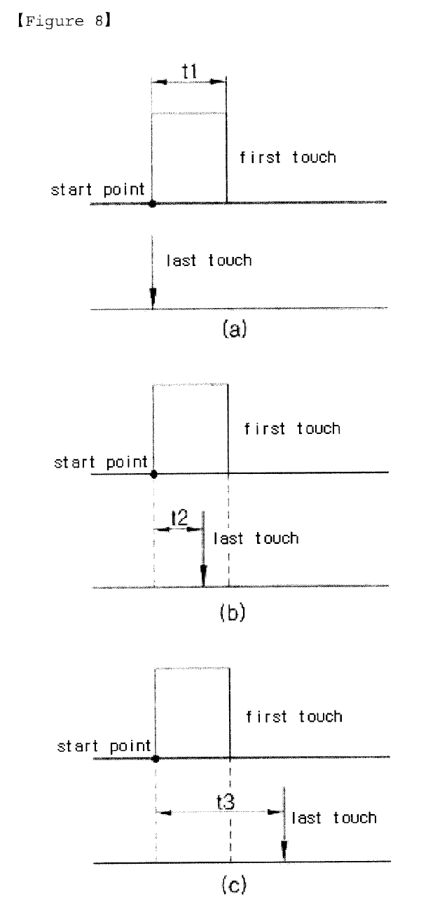

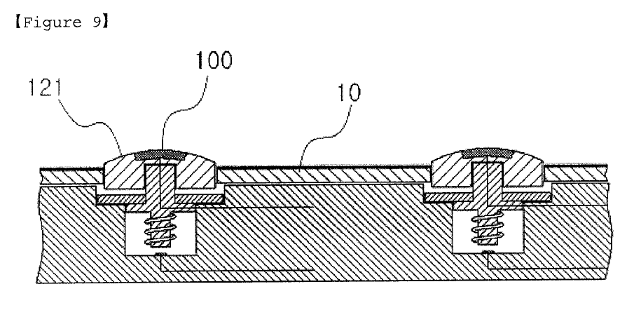

FIG. 1 is a view showing a mobile phone keypad, FIG. 2 is a perspective view implementing forty key values including an alphabet of A-Z as a key pad configured of press switches including eighteen touch sensors, FIG. 3 is a view showing data input example using the data input apparatus according to the present invention, FIG. 4 is a view showing a region of touch switches used for defining a unit cell selection method, FIG. 5 is a view showing a data input method using the data input apparatus according to the present invention, FIGS. 6 and 7 are views showing a data input method using a data input apparatus in another form according to the present invention, FIG. 8 is a view for explaining a simultaneous touch and FIG. 9 is a cross-sectional view showing a switch structure of a data input apparatus according to the present invention.

FIG. 1 shows the switches of the data input apparatus according to the present invention that are used as a keypad implemented in a mobile phone or a general phone.

FIG. 2 shows the data input apparatus according to the present invention that is implemented by a Qwerty keypad adopted as a standard in a typewriter or a computer.

The data input apparatus of the present invention comprises input switches 100 arranged in a matrix form where press switches 120 and touch switches 110 are integrally provided, wherein four neighboring input switches 100 are allocated to one unit cell 200 and input switches 100 on a border line of neighboring unit cells 200 are arranged in a matrix form to be shared each other, when input signals of the touch switches 110 are input by a simultaneous touch of more than two switches including a diagonal switches in the unit cell 200, the corresponding unit cell 200 is activated, and when signals are input from the press switches 120 by a press operation of any one input switch 100 of the four input switches in the activated unit cell 200, key values 300 allocated to the input switches 100 within the activated unit cell 200 are input.

The input switches 100 where press switches 120 and touch switches 110 are integrally provided are arranged in a matrix form. The input switches 100 are allocated to the unit cell 200, wherein the unit cell 200 to which the input switches 100 are allocated are in a matrix form to mutually share the input switches 100 on a border line of neighboring unit cells 200.

When the input signals of the touch switches 110 are input by a simultaneous touch of more than two switches including a diagonal switches in the unit cell 200 to which the input switches 100 are allocated, the input switches 100 activates the unit cell 200.

After the unit cell 200 is activated, when signals are input from the press switches 120 by the press operation of any one input switch 100 of the four input switches in the activated unit cell 200, the key values 300 allocated to the input switches 100 within the activated unit cell 200 are input.

At this time, if the unit cell 200 is activated, only the press switch 120 of the input switch 100 corresponding to the activated unit cell 200 is preferably operated

The aforementioned key input process will be described below.

The data input method of the data input apparatus according to the present invention will be described in detail below with reference to FIGS. 3 to 5.

For example, when intending to input “X”, the touch switch 110 corresponding to the unit cell 200 including “X” is first touched as shown in FIG. 3. At this time, more than two switches including the switches positioned at each diagonal direction in the input switch 100 corresponding to the unit cell 200 including “X” should be simultaneously touched to select the unit cell 200. When the corresponding unit cell 200 is selected, the corresponding unit cell 200 on the display 20 is activated and when the input switch 100 corresponding to “X” is pressed, the corresponding key value “X” is input.

FIG. 4 shows an input example of the touch switch for selecting the corresponding unit cell. FIG. 4(a) shows a simultaneous touch of the two touch switches 110 including the switches positioned at each diagonal direction corresponding to the corresponding unit cell 200 of the touch switch 110, FIG. 4(b) shows a simultaneous touch of the three touch switches 110 including the switches positioned at each diagonal direction corresponding to the corresponding unit cell 200 of the touch switch 110, and FIG. 4(c) shows a simultaneous touch of all the touch switches 110 corresponding to the corresponding unit cell of the touch switch 110, that is, the four touch switches.

FIGS. 4(a), (b), and (c) show a case where a cell selection is made by means of the touch of the touch switch 110.

On the other hand, FIG. 4(d) shows a case where the cell selection is not made. The touch switches 110 corresponding to the corresponding unit cell do not include the switches positioned at each diagonal direction so that the cell selection is not made.

The share of the input switches using the input example in FIGS. 3 and 4 will be described with reference to FIG. 5.

When the simultaneous touch is made by means of any one case selected from the touch switches (a1-b2), (a2-b1), (a1-a2-b2), (a1-b1-b2), (a1-a2-b1), (a2-b1-b2), (a1-a2-b1-b2), a unit cell Al is selected, when the input switch a2 is pressed, “W” is input, and when the input switch b2 is pressed, “S” is input. In other words, the input switches a2 and b2 each has key values of “W” and “S”.

In the case of a unit cell A2 sharing the input switches a2 and b2, the simultaneous touch is made by means of any one case selected from the touch switches (a2-b3), (a3-b2), (a2-a3-b2), (a2-a3-b3), (a3-b2-b3), (a2-b2-b3), (a2-a3-b2-b3), a unit cell A2 is selected, when the input switch a2 is pressed, a key value “E” is input, and when the input switch b2 is pressed, “D” is input.

Therefore, the input switches a2 and b2 are mutually shared and have different key values.

Also, in the case of the unit cell B1 sharing the input switches b1 and b2, the simultaneous touch is made by means of any one case selected from the touch switches (b1-c2), (b2-c1), (b1-b2-c2), (b1-c1-c2), (b2-c1-c2), (b1-b2-c1), (b1-b2-c1-c2), a unit cell B1 is selected, when the input switch b1 is pressed, a key value “Tab” is input, and when the input switch b2 is pressed, “Z” is input.

Therefore, the input switches b1 and b2 are mutually shared and have different key values.

In particular, in the case of the input switch b2, the key values “S”, “D”, “Z” are input according to the selected unit cell and the key values are different according to the selected unit cell.

The input apparatus of the present invention includes the unit cell arranged in a square and a rectangle as shown in FIGS. 1 to 3, as well as the unit cell arranged in a parallelogramas shown in FIG. 6.

When the input switch is arranged in the parallelogram, it has an advantage capable of easily performing the simultaneous touch of the adjacently positioned switches (a7 and a8 switches of FIG. 6) of the diagonal switches within the unit cell as compared to arranged in the square. This will be described based on FIG. 6. The input switches a5, a7, a1, and a8 configure one unit cell, the unit cell is selected by means of a simultaneous touch of the input switches a7 and a8, and the a5, a7, a10, and a8 corresponding to the selected unit cell can input each key value.

On the other hand, the input apparatus according to the present invention comprises the one unit cell that may be configured of the three input switches, not the four input switches in the case of the unit cell configured of the input switches positioned at the outermost as shown in FIG. 6. More specifically, the input apparatus further comprises one unit cell that is configured of the three input switches a1, a2, and a4 including the input switches al and a2 adjacently positioned at the outermost. In this case, the corresponding unit cell is activated by means of the diagonal simultaneous touch of the unit cell configured of the three input switches, that is, the simultaneous touch of the input switches a1 and a2 positioned at the outermost and when the activated unit cell receives the signal from the press switch by the press operation of any one input switch configuring the unit cell, likewise the case where the unit cell configured of the four input switches is activated, the key values allocated to the input switches within the activated unit cell can be input.

In order to efficiently use the input switches positioned at the outermost, cell selection auxiliary switches for activating the unit cell including the outermost input switches are further provided, as the touch switches, outside the input switches positioned at the outermost so that the input switches positioned at the outermost can be implemented to have four input values. Referring to FIG. 7, the cell selection auxiliary switches b2 and b3 are simultaneously touched so that the unit cell configured of a2, b3, and b2 can be activated and the key value of a2 allocated to the corresponding unit cell can be input by means of the press operation of a2 and the input switch a7 and the cell selection auxiliary switch b6 are simultaneously touched so that the unit cell configured of a7, a4, b6, and b7 can be activated and the key values of a4 or a7 allocated to the corresponding unit cell can then be input by means of the press operation of a4 or a7. Using the methods, it is possible for all the input switches to each have the four input values, respectively.

Also, the unit cell 200 activated by the touch of the touch switch 110 remains activated in the state before the input of the input switch 100 allocated to the activated unit cell 200.

At this time, the unit cell 200 activated by the touch of the touch switch 110 remains activated in the state before the input of the input switch 100 corresponding to the activated unit cell 200. In other words, the key value is input only by the input of the input switch 100 corresponding to the activated unit cell 200 and the key value is not input by the input of the input switch 100 of a non-activated unit cell.

The meaning of the simultaneous touch is that more than two touch switches including the diagonal switches in the unit cell are simultaneously touched and the touch switches in the unit cell are sequentially touched within predetermined time, and in particular, includes one recognized as the simultaneous touch when the touch switch first touched in the unit cell has predetermined touch holding time from the time of the first touch and the touch point in time of the touch switch last touched is in the touch holding time and one recognized as the simultaneous touch when the touch point in time of the touch switch first touched and the touch point in time of the touch switch last touched in the unit cell are in predetermined time.

FIG. 8(a) shows a case of a complete simultaneous touch. FIG. 8 (b) and FIG. 8(c) show a sequential generation of the touch of the first touch switch and the touch of the final touch switch. At this time, in the sequential touch of the touch switch, the touch of the first touch switch has predetermined time, that is, touch holding time (t1). FIG. 8(b) shows the case where the unit cell selection is made by being recognized as the simultaneous touch by means of the first touch operation condition and the final touch operation condition as the case where the final touch is generated within the touch holding time (t1) of the first touch switch. FIG. 8(c) shows the case where the unit cell selection is not made by means of the first touch and the final touch as the case where the final touch is generated in (t3) after the touch holding time (t1) of the touch switch first touched.

When using the touch holding time in the sequential touch, it is preferably within 0.05 seconds in consideration of a feature of the touch operation and when adopting the touch point in time, it is preferably within 0.1 seconds.

Also, in order to prevent the unit cell selection error due to the error touch, the design with respect to the size and shape of the input switch and the shape and size of the touch portion is important. The proper selection of the conditions for the simultaneous touch in consideration of the variables of the input switches and the touch portions belongs to the present invention.

Preferably, the present invention displays the unit cell selection information and the key value information on the plate 10 or the display 20 around the input switch.

The unit cell selection information is displayed through a specific color display around the activated unit cell selection switch, making it possible to easily recognize the unit cell selection position of a user and the activation or not.

Preferably, the input switch 100 of the present invention is provided in a dome shape protruded upward and the touch switch 110 is formed only at a central portion of the dome 121, as shown in FIG. 9. The position of the touch point is limited only to a portion of the input switch, making it possible to prevent the error touch of the adjacent unit cell, enlarge the size of the input switch, and reduce the interval.

### INDUSTRIAL APPLICABILITY

As above, the data input apparatus according to the present invention implements a large number of the key values with a small number of the input switches and has the unit cell selection step that is a first step of the input, making it possible to facilitate the input position confirmation and implement the blind touch. Also, the present invention has an effect that the movement of the input operation can be minimized and the intuitional input can be performed.

1. A data input apparatus comprises input switches arranged in a matrix form where press switches and touch switches are integrally provided, four neighboring input switches being allocated to one unit cell and unit cells being allocated in a matrix form so as to mutually share input switches on a border line of neighboring unit cells, in and arranged so that when input signals are input from the touch switches by a simultaneous touch of more than two input switches including a diagonal switches in the unit cell, the unit cell including the touched input switches is activated; when signals are input from the press switches by a press operation of any one input switch configuring the activated unit cell, key values allocated to the input switches within the activated unit cell are input; and the activated unit cell by the touch of the touch switch is arranged to remain activated before the neighboring unit cells sharing the input switches are activated.

2. The apparatus according to claim 1, wherein the one unit cell is configured of three input switches including two neighboring input switches positioned at the outermost, the corresponding unit cell is arranged to be activated by a simultaneous touch of the two input switches positioned at the outermost, when signals are input from the press switches by the press operation of any one input switch configuring the activated unit cell, key values allocated to the input switches within the activated unit cell are input.

3. The apparatus according to claim 1, further comprising cell selection auxiliary switches for activating the unit cell including the input switches positioned at the outermost, which are provided at the outside of the input switches positioned at the outermost.

4. The apparatus according to claim 1, wherein the apparatus is arranged such that when the unit cell is activated, only the press switches of the input switches configuring the activated unit cell are operated.

5. The apparatus according to claim 4, wherein the input switch is provided in a dome shape protruded upward and the touch portion of the touch switch is formed only at a central portion of the dome.

6. The apparatus according to claim 1, wherein the simultaneous touch includes a sequential touch of the touch switches in the unit cell within predetermined time.

7. The apparatus according to claim 6, wherein the case where the touch switch first touched in the unit cell has predetermined touch holding time from the time of the first touch and the touch point in time of the touch switch last touched is in the touch holding time is recognized as the simultaneous touch.

8. The apparatus according to claim 6, wherein the case where the touch point in time of the touch switch first touched and the touch point in time of the touch switch last touched in the unit cell are in predetermined time is recognized as the simultaneous touch.

9. The apparatus according to claim 1, wherein the activated unit cell information and the key value information are displayed on a plate or a display around the input switch.

10. A data input method for a data input apparatus comprising input switches arranged in a matrix form comprising press switches and touch switches, four neighboring input switches being allocated to one unit cell and unit cells being allocated in a matrix form so as to mutually share input switches on a border line of neighboring unit cells, the method comprising:
activating a unit cell including touched input switches responsive to input signals input from the touch switches by a simultaneous touch of more than two input switches including diagonally-related switches in the unit cell;
inputting key values allocated to the input switches within the activated unit cell responsive to signals input from the press switches by a press operation of any one input switch configuring the activated unit cell; and
wherein the activated unit cell by the touch of the touch switch is arranged to remain activated before the neighboring unit cells sharing the input switches are activated.
